(19) United States
(12) Patent Application Publication
(10) Pub. No.: US 2007/0078766 A1
(43) Pub. Date: Apr. 5, 2007

(54) Charitable donations via ATMs

(76) Inventor: Michael R. Thomas, San Francisco, CA (US)

Correspondence Address: GLENN PATENT GROUP, 3475 EDISON WAY, SUITE L, MENLO PARK, CA, 94025, US

(21) Appl. No.: 11/242,978

(22) Filed: Oct. 3, 2005

(51) Int. Cl. G06Q 40/00

(52) U.S. Cl. 705/43

(57) ABSTRACT

A methodology for providing customers of an enterprise with ability to make donations to selected charities via a new transaction flow at ATMs is provided. The transaction is like a debit transaction. A transaction is described that works similarly to a transfer function. The transaction can be for the enterprise's customers; can be for ATMs; can be in any of a variety of available languages; and can have a fixed number of charity options per ATM. The ATMs can be grouped by geography or other criteria. The transaction options can be determined by region and can be updated on a periodic basis. The ability to update options within hours to support disaster-relief efforts is described. The receipt can print a donation disclaimer and the receipt printing can be automatic and override established printing preferences.

### BACKGROUND OF THE INVENTION

1. Technical Field

The invention relates to automated teller machines (ATMs). More particularly, the invention relates to a system and process for customers of an enterprise, such as a financial institution, to be able to donate to selected charities via ATMs, including transferring donations from the enterprise accounts to accounts of selected charities.

2. Description of the Prior Art

Automated teller machines (ATMS) are found throughout the world in a variety of settings and have become an assumed component of the lifestyle of millions. They operate at hours and in locations not serviced by regular financial institutions, providing a significant set of services to anyone possessing an access card and password sequence, which is often a four keystroke sequence known as a Personal Identification Number (PIN). Thus access to a user's finances can be attained. Cash can be received and/or transferred, which is, accordingly, credited to or debited against the account. The account status can be viewed, as can a log of recent transactions. While such services are extremely valuable, there are still a number of additional needs not serviced by such devices at this time.

Presently, customers of banks and other financial institutions with ATMs are able to transfer funds from one account to another while logged onto an ATM. It has never before been conceived to adapt ATM technology to provide ATM customers the ability to make a donation from one of the customer's accounts on the ATM to a charity of choice. This ability would provide customers with a new and easy way of contributing to a charity. This ability would also offer selected charities with a new way of securing charitable donations. It would therefore be advantageous to provide a system and method for ATMs to include charitable donation functionality.

Various schemes have been devised that address donations and transaction systems. For example, Jens H. Molbak, Carol Lewis, Johanna Carlson, and Michael Doran, U.S. Pat. No. 5,909,794, Donation Transaction Method and Apparatus (Jun. 8, 1999) discuss a donation transaction apparatus and method for facilitating donations to charitable organizations is provided, where the apparatus is configured to receive coins or, in some embodiments, cash or funds transfer authorization or credit charges, and preferably dispenses a donation receipt to the user which the user may use to prepare or document income tax returns. The user is able to select among a plurality of charitable organizations to receive the donation.

It should be appreciated that Molbak et al at the least does not provide a customer, while logged onto the ATM, the ability to transfer funds from any of the customer's linked accounts to a variety of charities on the spot.

Richard A. Han, U.S. Patent Application Publication No. US 2003/0093293 A1, Transaction System (May 15, 2003) discusses a method of and an apparatus for levying a surcharge as a result of a self-service terminal transaction where the surcharge may be paid, in part or in full, to a charity.

It should be appreciated that Han does not provide a customer, while logged onto the ATM, the ability to transfer funds from any of the customer's linked accounts to a variety of charities on the spot, nor even the ability to provide the choices of charities by region.

Tandy Willeby, International Publication No. WO 02/19282 A2, System and Method for Online ATM Transaction with Digital Certificate (Mar. 7, 2002) discusses a system and method for performing a secure ATM debit transaction for a buyer making a payment to a seller over the Internet. The ATM debit network links together a plurality of banks, financial institutions, and ATM machines. The seller web site is accessible to the buyer via the Internet. The transaction computer system is adapted to be communicably coupled to the seller web site and the ATM debit network as needed to perform the secure ATM debit transaction. The software program on the transaction computer system is adapted to authorize and facilitate the secure ATM transaction between the seller and the buyer using at least one digital certificate. When the secure ATM transaction is authorized by at least authenticating the at least one digital certificate, the software program submits a debit request to the ATM debit network corresponding to the secure ATM debit transaction.

It should be appreciated that Willeby does not provide the ability for a user to donate to the variety of charities directly and in the many modes such as in different languages and media.

Mario Ragusa and Nathan Cooper, International Publication No. WO 2004/034292, Making Financial Contributions (Apr. 22, 2004) discuss a financial contribution is made to a designated charity fund using electronic transaction apparatus. The electronic transaction apparatus is used to read a designated charity fund identification device which has stored on it a designated charity fund identifier which identifies the charity fund to which the financial contribution is made. The financial contribution is acquired from a participant who is making the financial contribution and the designated charity fund is automatically credited with the amount in an electron financial transaction, directly into a designated charity fund account.

It should be appreciated that Ragusa et al does not provide the ability or the convenience for a user to donate while making transactions at an ATM to the variety of charities directly and in the many modes such as in different languages and media.

In BancNet Revolutionizes e-Payments; www.bancnetonline.com; BancNet, Inc; 2004, the Web page discloses a transfer of funds where BancNet “gives you the flexibility to move funds from one account to the other, be it your own or that of another person, for as along as all parties concerned are BancNet cardholers.”

It should be appreciated that nowhere does the article teach a method and apparatus for providing a variety of charities relevant to a region or other criteria such that a user, while at an ATM, can transfer funds to one or more selected charities, in a language and media preferred to the user, and receiving a receipt compliant with tax rules so that the user can verify he or she made such contribution.

It would be advantageous to provide a system and process of transferring funds between accounts by providing the ability to transfer donations from existing accounts to accounts of selected charities.

### SUMMARY OF THE INVENTION

A methodology for providing customers of an enterprise with the ability to make donations to selected charities via a new transaction flow at automated teller machines (ATMs) is provided. In one embodiment of the invention the transaction is a debit transaction. The transaction can have a general description, “Charitable Donation,” on customer statements, for example. One embodiment of the invention provides a flow for such a transaction and works similarly to a transfer function. The transaction can be for the enterprise's customers only; can be for ATMs, including Web-enabled ATMs; can be in multiple languages, including but not limited to English, Spanish, Chinese, Korean, Vietnamese and Hmong; and can have a fixed number of charity options, e.g. six, at each ATM. In one embodiment of the invention, the charities selected for each ATM are targeted by geography or other criteria and are updated on a periodic basis, such as every two months. One embodiment of the invention provides an ability to update charity selections within hours to support disaster-relief efforts. Also provided is a receipt that prints a donation disclaimer. Such receipt printing can be automatic, optionally overriding printing preferences, such as for example, Wells Fargo's myATM.

### BRIEF DESCRIPTION OF THE DRAWINGS

FIG. 1 is a schematic diagram of a system architecture according to an embodiment of the invention;

FIG. 2 is an example screenshot of a More Choices screen according to the invention;

FIG. 3 is an example screenshot of a Charity Selection screen according to the invention;

FIG. 4 is an example screenshot of an Account screen according to the invention;

FIG. 5 is an example screenshot of an Amount screen according to the invention;

FIG. 6 is an example Donation Confirmation screen according to the invention; and

FIG. 7 is a table showing configuration selections for charitable donations via WebATM according to the invention.

### DETAILED DESCRIPTION OF THE INVENTION

A methodology for providing customers of an enterprise with the ability to make donations to selected charities via a new transaction flow at automated teller machines (ATMs) is provided. In one embodiment of the invention the transaction is a debit transaction. The transaction can have a general description, “Charitable Donation,” on customer statements, for example. One embodiment of the invention provides a flow for such a transaction and works similarly to a transfer function. The transaction can be for the enterprise's customers only; can be for ATMs, including Web-enabled ATMs; can be in multiple languages, including but not limited to English, Spanish, Chinese, Korean, Vietnamese and Hmong; and can have a fixed number of charity options, e.g. six, at each ATM. In one embodiment of the invention, the charities selected for each ATM are targeted by geography or other criteria and are updated on a periodic basis, such as every two months. One embodiment of the invention provides an ability to update charity selections within hours to support disaster-relief efforts. Also provided is a receipt that prints a donation disclaimer. Such receipt printing can be automatic, optionally overriding printing preferences, such as for example, Wells Fargo's myATM.

It should be appreciated that such description herein is meant by way of example only and is not meant to be limiting. It should further be appreciated that ATMs and Web-enabled ATMs can be used interchangeably herein.

In one embodiment of the invention, the Charitable Donation transaction is under a “More Choices” menu and is advertised in available advertisement space on a Main Menu as well as other available spaces.

In one embodiment of the invention, charities available on the ATMs are chosen from within a particular region of the enterprise. A region is defined by the enterprise as a geographically distinct area equal to or within the geography served by the enterprise. For example, six charities can be available for customers to choose from in each region. Each region can have the opportunity to update its list of charities periodically, such as every two months. In one embodiment of the invention, a charity database is developed to manage available charities and lists thereof.

In one embodiment of the invention, to support disaster-relief efforts, the enterprise is capable of quickly, e.g. within 48 hours, updating charitable selections available on ATMs. Such update may apply to all ATMs or may be targeted to ATMs in one or more regions.

In one embodiment of the invention, customers are able to select from various available accounts to make donations, such as for example, from deposit accounts. In other embodiments of the invention, credit card accounts and direct deposit advance accounts may not be available for charitable donations. It should be appreciated that the types of accounts put forth herein are meant by way of example only and are not meant to be limiting.

In one embodiment of the invention, the enterprise disburses donations electronically to participating charities. In one embodiment of the invention, the disbursement service is offered free of charge to the customer.

In one embodiment of the invention, customer information is not shared with the participating charities.

In one embodiment of the invention, denials for non-sufficient funds (NSF) and for overlimits follow existing business rules and flows.

An Exemplary System Architecture

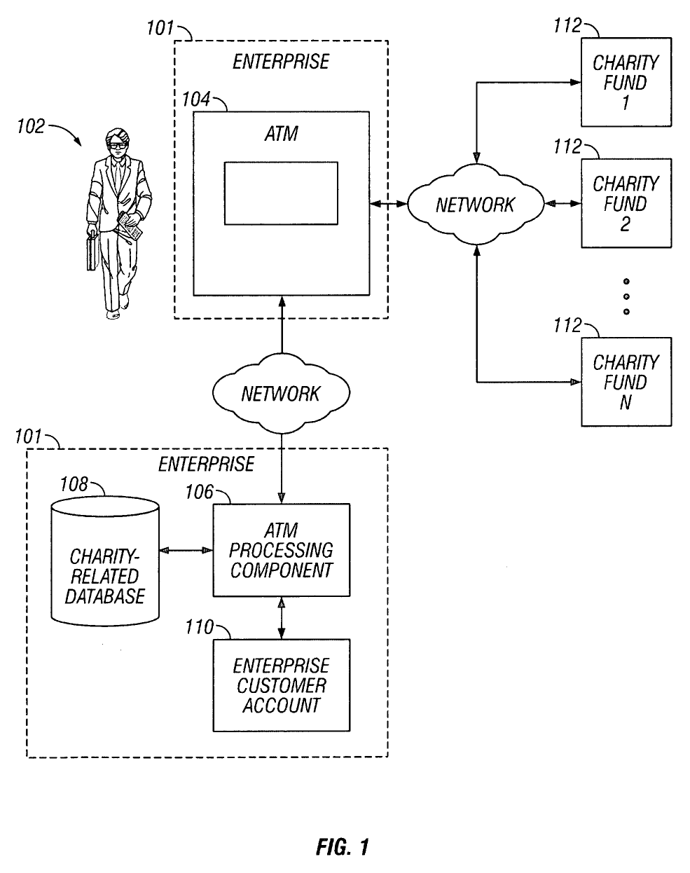

An exemplary system architecture of an embodiment of the invention can be described with reference to FIG. 1. A customer 102 desires to make a transaction at an ATM 104. It should be appreciated that while, for illustrative purposes, the ATM is depicted as a physical device, the invention encompasses other platforms for the ATM, such as for example, an electronic financial apparatus. Through one or more secure networks, the ATM 104 is communicatively coupled to the ATM's processing component including charity-related processing capability 106. The ATM processing component 106 is communicatively coupled to an enterprise database 108 that comprises charity-related data. In cases when the customer has an account with the enterprise, the ATM processing component 106 is communicatively linked to the customer's account 110. From combining processing using any of these components, the ATM disburses payment via one or more secure networks to one or more charity funds 112.

It should be appreciated that the ATM processing component or parts thereof can reside on the ATM itself or reside on a separate server communicatively coupoed to the enterprise 101. Functionality performed by the ATM processing component 106 include, but is not limited to: accessing funds, sending electronic messages, reading profiles to determine preferences, writing receipts, being updated by the enterprise, being configured to offer geographically targeted charities, being configured according to other criteria, being updated periodically, and being configured to assist in disaster-relief funding.

An Exemplary Transaction Screen Flow

In one embodiment of the invention, a new transaction type, such as for example, “Charitable Donation” is added under a choices option, such as “More Choices.” It should be appreciated that such screen flow generally mimics a Transfer screen flow, with screens added as needed. Descriptions of example screenshots follow hereinbelow.

More Choices Screen.

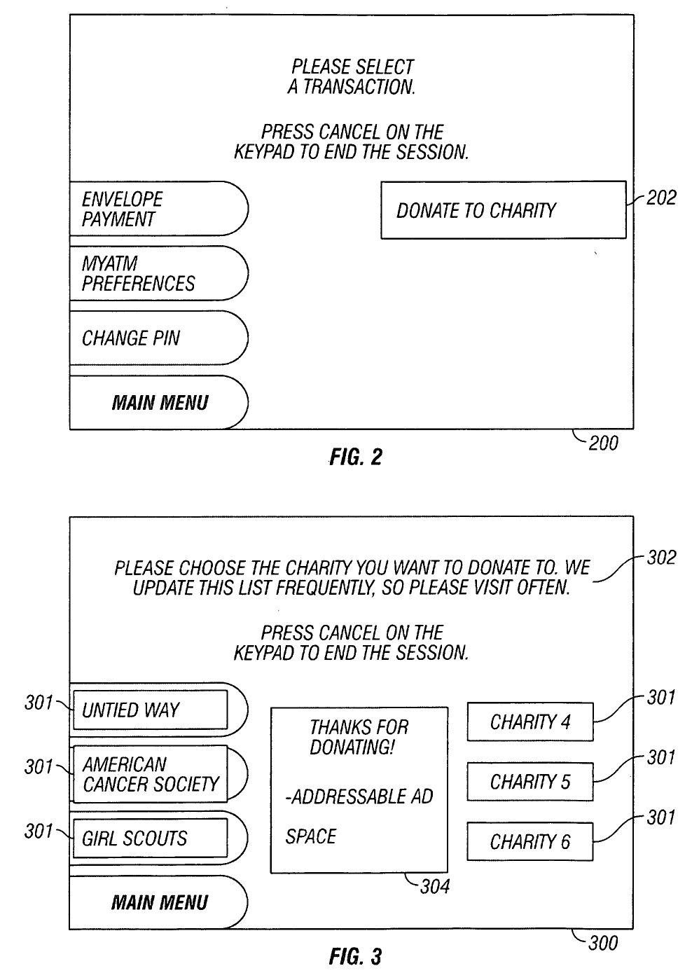

A More Choices screen is described with reference to FIG. 2, an example screenshot of a More Choices screen 200. On this screen, the customer can select the new “Donate to Charity” button 202 on the “More Choices” screen.

Charity Selection Screen.

A Charity Selection screen is described with reference to FIG. 3, an example screenshot of a Charity Selection screen 300. On this screen the customer can select a charity. In this example, six charities are listed by name. Each region is able to offer its own list of charities. In one embodiment of the invention, if a region does not offer its own charities, then, default charities, which do not have to be specific to any region, are offered. As an example, refer to the charities 301 offered in FIG. 3. Such lists can be updated as desired, such as every two months. The customer selects to which ones of the six listed charities he or she wishes to donate. For example, to aid in disaster-relief efforts, a region or regions can update charity selections on this screen within 48 hours. In one embodiment of the invention, such screen can include a message 302 similar to: “Please choose the charity to which you want to donate. We update this list frequently, so please visit often.” In addition to the preceding message, which is part of the transaction screen, an advertisement space 304 on the screen can offer a general message, such as, for example, a message of encouragement along the lines of: “Thanks for donating!”

Account Screen.

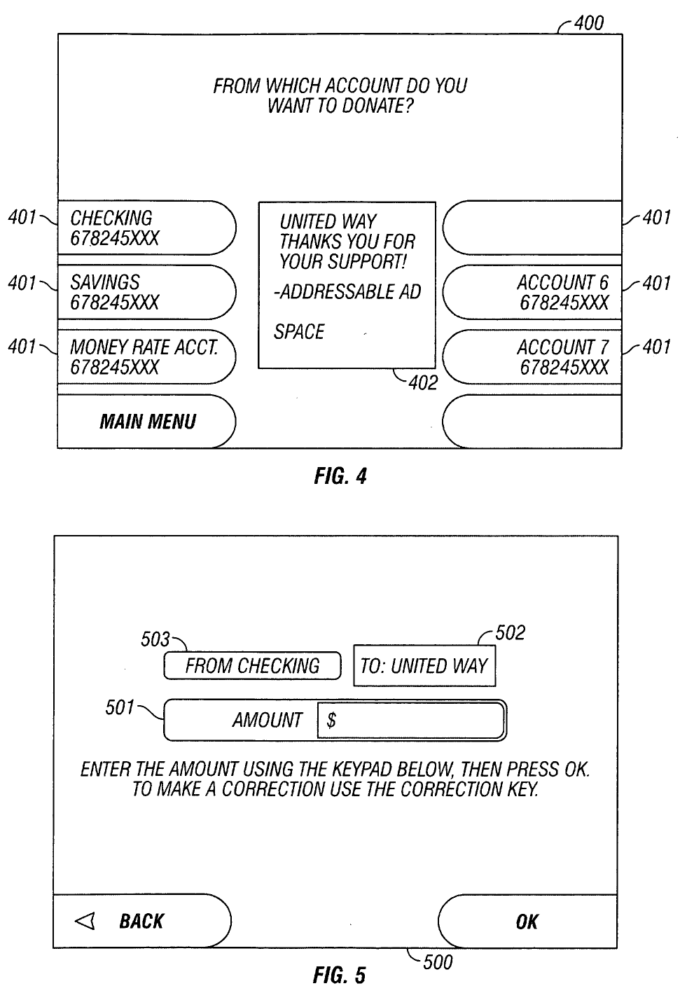

An Account screen is described with reference to FIG. 4, an example screenshot of an Account screen 400. On this screen the customer can select from which available account 401 the customer wants to donate. The invention can incorporate a multitude of business rules. In one embodiment of the invention, the business rule hereinbelow is incorporated. It should be appreciated that such business rule is meant by way of example only and is not meant to be limiting.

Business Rule: Deposit accounts only. Exclude Credit card accounts and Direct Deposit Advance.

In one embodiment of the invention, an advertisement space 402 on such Account screen is related to a customer's charity choice on the preceding screen. For example, according to one embodiment of the invention, such ad provides information about the charity and/or thanks the customer for supporting that charity.

Amount Screen.

An Amount screen is described with reference to FIG. 5, an example screenshot of an Amount screen 500. On this screen the customer can enter the amount of the donation 501. In this example, the customer inputs the amount of the donation, which may be limited to $249.99. Such amount is input by the customer using the ATM's keypad and includes a decimal point. The selected charity's name is indicated 502 and the selected account is indicated 503. Following are two example business rules according to one embodiment of the invention.

Business Rule: If amount entered exceeds $249.99, the customer is asked to enter an amount lower than $249.99.

Business Rule: Denials for non-sufficient funds (NSF) and Overlimit follow existing rules and flows.

Donation Confirmation Screen.

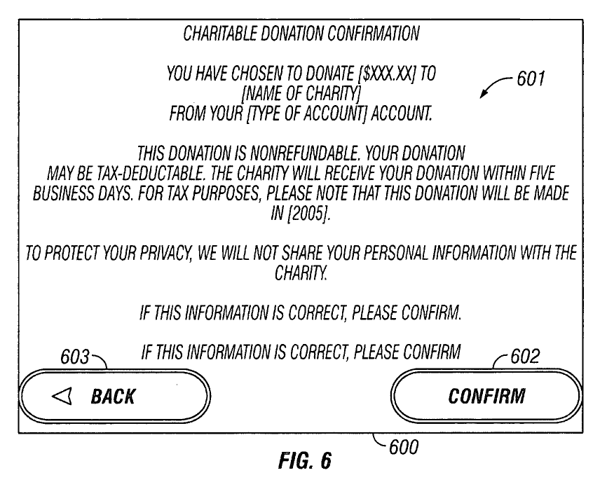

A Donation Confirmation screen is described with reference to FIG. 6, an example Donation Confirmation screen 600. On this screen the customer confirms the details of the donation, such as for example, the donation amount, name of selected charity, account selected, and the year the donation is made 601. In this example implementation, the customer is reminded that donations are nonrefundable , informed that donations may be tax-deductible, informed that their donation will be received by the charity within five business days, informed of the year in which the donation will be made, informed that their personal information will not be shared with the charity, and asked to confirm the donation 601. If the customer indicates CONFIRM 602, then the ATM prints a receipt, and the customer is shown a screen asking if the customer would like another transaction. If the customer indicates BACK 603, then the customer is shown a screen, which asks if the customer would like another transaction.

It should be appreciated that the figures discussed hereinabove show an embodiment of a process according to the invention at an ATM by which a customer of the enterprise can select a charity, select the customer account from which the donation will be debited, and select the donation amount.

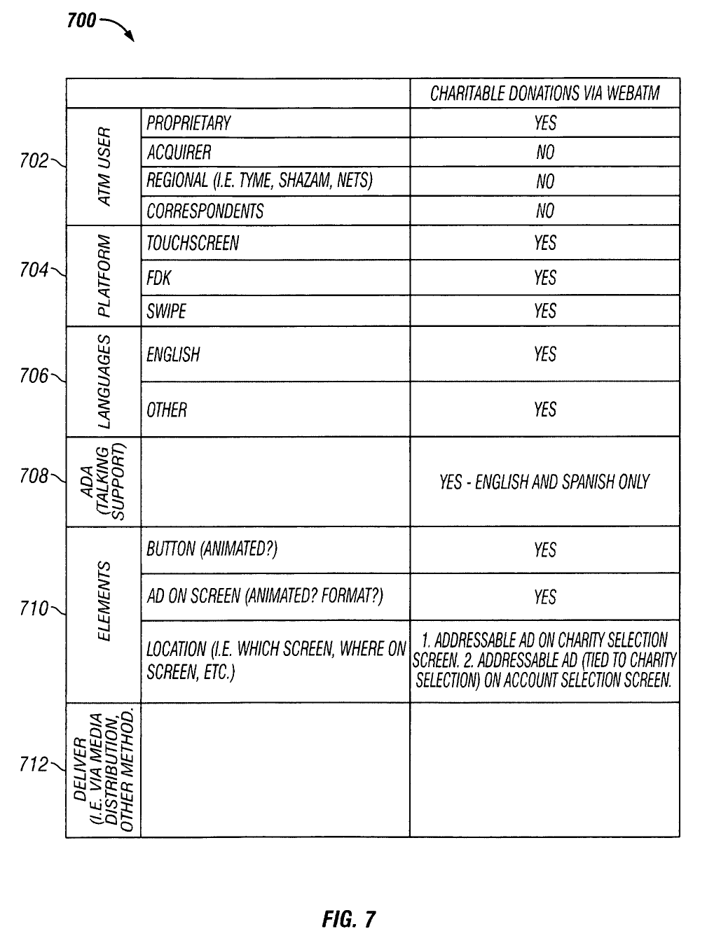

FIG. 7 is a table showing an example configuration selection for charitable donations via WebATM 700 according to the invention. In this example, the type of ATM user 702 configured to make a charitable donation via the WebATM is a proprietary user. In this example, the type of platforms 704 configured to facilitate charitable donations via the WebATM are touchscreen, FDK, and Swipe. In this example, the type of languages 706 configured to be used for charitable donations via the WebATM are English and Other. Similarly, in the example, each of the following are configured to support charitable donations via the WebATM: Talking Support 708, user interface elements 710, and mode of distribution 712.

An Exemplary ATM Receipt for Charitable Donation

In one embodiment of the invention, in addition to standard receipt information, the receipt specifies that this transaction is a charitable donation and includes information about the charity, e.g. name and contact info, and a disclaimer. An example of disclaimer text is provided hereinbelow and is subject to confirmation by an enterprise's legal consultation. Below in Table A is example disclaimer information kept on one receipt sheet.

TABLE A
Receipt for Charitable Donation:

| | | |
|---|---|---|
| Date: | Time: | Location: |
| XX/XX/XX | XX:XX a.m. | XXXXXXX |

| Customer Card: | ATM: |
|---|---|
| XXXXXXX1234 | XXXXX |
| Transaction Type: Charitable Donation | |
| Transaction No.: XXXXX | |
| Amount: | $XXX.XX |

From: Account #: 1234567XXX
Year of Donation: XXXX
Charity Selected: XXXXXXXXXXXXXX
Charity Contact Information:
XXXXXXXXXXXXXXXXXXXXXXXXXXXX
XXXXXXXXXXXXXXXXXXXXXXXXXXXXXX
Thank you for donating to charity via this Wells Fargo
ATM. Your donation may be tax-deductible. The
charity will receive your donation within five business
days. Your personal information will not be shared with
the charity. The charity will not be able to confirm
your donation. Keep this ATM receipt for your records.

Providing Donations to Charities

In one embodiment of the invention, a particular enterprise department is responsible for working with the enterprise's ATM banking group to provide access to the list of possible charities able to accept donations, and developing such service as an enterprise product. In addition to remitting funds, the new product or service can enable the enterprise to provide charities a data record about each customer donation. In one embodiment of the invention, such customer information includes: Donation amount; Donation date; and Tracking number.

Charity Selection Database

In one embodiment of the invention, a charity database facilitates and accommodates the regions' ability to select charities. Such database processing includes, but is not limited to, functionality to:
Identify ATMs by region;
Accept charity selections by region;
Accept updates to regions' charity selections on a periodic, e.g. bi-monthly, basis;
Accept emergency updates, e.g. implemented within 48 hours, to accommodate disaster-relief efforts, either to all ATMs or to ATMs within one or more regions;
Accept updates about which ATMs are in which regions; and
Maintain charity name and contact information and make that information available for printing on the ATM receipt.
   Support for Disaster Relief

To support disaster-relief efforts, one embodiment of the invention provides ability to quickly, e.g. within 48 hours, update charitable offerings available on ATMs. Such update may apply to all ATMs or may be targeted to ATMs in one or more regions.

An Exemplary Technical Flow

One embodiment of the invention provides the following exemplary technical flow. It should be appreciated that such flow is by way of example only and is not meant to be limiting.
A customer donates at ATM;
A transaction log is generated;
Such transaction log is sent to CZ, a charity-related processing component;
CZ debits the customer account within the enterprise and credits a single charity DDA in another or the same system within the enterprise which combines all the charitable donations;
CZ optionally creates a file for a second software system, which determines donation allocation, including the following information:
   Charitable donation records: Details of each donation for each charity, including:
      Customer account debited;
      Donation amount;
      Donation date;
      Charity name;
      Charity name (as written on ATM screen);
      Tax Identification Number (TIN);
      Routing and Transit information (BIN and Acct.); and
      Preference for e-mail or fax (for donor information);
   Summary of total records for each charity; and
   Possible file headers and trailers.
CZ sends flat file to the second software system; and
The second software system debits the charity DDA and uses the flat file to distribute funds to charities.
   Additional Elements (Media)

One embodiment of the invention provides ATM screens in multiple languages, which may include English, Spanish, Chinese, Korean, Vietnamese and Hmong, and also in audio, which may include English and Spanish.

Tracking and Testing

One embodiment of the invention tracks the customer, amount, date, charity, ATM, and canceled transactions data to provide reporting that includes, but is not limited to:
Breakdown by day, week, month, quarter, year;
Total donation amounts;
Total number of customer-donors;
Donation totals by charity;
Customer-donors by charity;
Donation totals by region;
Customer-donors by region;
Average donation amount by charity; and
Average donation amount by region.

It should be appreciated that the list hereinabove is by way of example only and is not meant to be limiting.

Potential Market

It should be appreciated that a potential market is identified as enterprise customers use ATMs to conduct transactions.

Benefits

Following are some identified benefits of the invention. It should be appreciated that the list hereinbelow is not exclusive.

For the enterprise:
Excellent customer service;
Enhanced support for communities in which the enterprise conducts business; and
Good public relations for the enterprise.

For Customers:
New way to contribute to worthy causes.

For Charities:
New channel to secure donations; and
New opportunity to raise awareness of efforts.
   Non-Customer-Related Donations

One embodiment of the invention provides donations from non-customers. A limited form is offered to a non-customer in the case that no receipt is required by the non-customer. According to another embodiment of the invention, the enterprise donates the surcharge fee, e.g. one-dollar ($1), charged to non-customers to charities for set periods of time. In another embodiment of the invention, donation promotions are targeted to non-customers who use the enterprise's ATMs only for a pre-determined amount of time, such as once a month, i.e. “For all future cash withdrawals this month, we will donate $1 of your convenience fee to charity.” In should be appreciated that in such scenarios, the enterprise is the donor and therefore would not need acquirer cardholder information for tax or other legal purposes.

List of Selected Charities Based on Language Selection

One embodiment of the invention provides for the selection of charities based on a customer's decision to conduct transactions in Spanish, Chinese, Hmong, Vietnamese, or Korean. As such, charity selections are based on ties to each language-based community.

Matching Employee Donations

One embodiment of the invention provides support for a marketing and/or promotional effort, whereby regions can choose to match donations made by the enterprise's employees.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method for a customer to make a charitable donation using an ATM, comprising the steps of:
a customer having an account at an enterprise requesting to make a donation from said customer account to a designated charity at an ATM coupled to said customer account;
said ATM comprising software wherein said ATM software generates a transaction log;
said ATM through a communicating device sending said transaction log to a software system that debits said customer account and credits a single account responsible for combining all the charitable donations;
said software system creating a file for said single charity account for determining a donation allocation;
said software system sending said file to said single charity account; and
said single charity account crediting said designated charity by using said file.

2. The method of claim 1, wherein said file includes any of the following information:
for charitable donation records, details of each donation for each charity, including:
customer account debited;
donation amount;
donation date;
charity name;
charity name;
Tax Identification Number;
routing and transit information; and
preference for e-mail or fax for donor information; and
summary of total records for each charity;

3. The method of claim 1, further comprising the step of:
applying existing overdraft protection functionality.

4. The method of claim 1, further comprising the step of:
providing tracking and testing functionality.

5. The method of claim 4, wherein tracking and testing functionality comprises any of:
breakdown by day, week, month, quarter, year;
total donation amounts;
total number of customer-donors;
donation totals by charity;
customer-donors by charity;
donation totals by region;
customer-donors by region;
average donation amount by charity; and
average donation amount by region.

6. The method of claim 1, further comprising any of the steps of:
providing capability for acquirer-related donations; and
providing capability for matching team member donations.

7. An apparatus for a customer to make a charitable donation using an ATM, comprising:
means for a customer having an account at an enterprise requesting to make a donation from said customer account to a designated charity at an ATM coupled to said customer account;
ATM software wherein said ATM software generates a transaction log;
a communicating device through which said ATM sends said transaction log to a software system that debits said customer account and credits a single account responsible for combining all the charitable donations;
means for said software system creating a file for said single charity account for determining a donation allocation;
means for said software system sending said file to said single charity account; and
means for said single charity account crediting said designated charity by using said file.

8. The apparatus of claim 7, wherein said file includes any of the following information:
for charitable donation records, details of each donation for each charity, including:
customer account debited;
donation amount;
donation date;
charity name;
charity name;
Tax Identification Number;
routing and transit information; and
preference for e-mail or fax for donor information; and
summary of total records for each charity;

9. The apparatus of claim 7, further comprising:
means for applying existing overdraft protection functionality.

10. The apparatus of claim 7, further comprising:
tracking and testing functionality.

11. The apparatus of claim 10, wherein said tracking and testing functionality comprises any of:
breakdown by day, week, month, quarter, year;
total donation amounts;
total number of customer-donors;
donation totals by charity;
customer-donors by charity;
donation totals by region;
customer-donors by region;
average donation amount by charity; and
average donation amount by region.

12. The apparatus of claim 7, further comprising any of:
capability for acquirer-related donations; and
capability for matching team member donations.

13. A method for providing customers of an enterprise ability to make donations to selected charities via an ATM, comprising the steps of:
providing a charitable donation transaction option to a customer, wherein said charitable donation transaction option provides a pre-determined number of different charities to which to donate;
providing means for updating said pre-determined number of different charities on a periodic basis; and
providing an automatic receipt for said customer.

14. The method of claim 13, wherein any of the following applies:
said customer is a particular type of customer;
said provided charitable donation transaction option is in a variety of languages;
ATMs are grouped by region or other criteria;
said provided charitable donation transaction option supports disaster-relief efforts by being updatable in a pre-determined quick amount of time;
said receipt can have printed on it a donation disclaimer;
said receipt printing is automatic; and
said receipt printing overrides printing previously determined preferences.

15. An apparatus for providing customers of an enterprise ability to make donations to selected charities via an ATMs, comprising:
a charitable donation transaction option to a customer, wherein said charitable donation transaction option provides a pre-determined number of different charities to which to donate;
means for updating said pre-determined number of different charities on a periodic basis; and
an automatic receipt for said customer.

16. The apparatus of claim 15, wherein any of the following applies:
said customer is a particular type of customer;
said provided charitable donation transaction option is in a variety of languages;
ATMs are grouped by region or other criteria;
said provided charitable donation transaction option supports disaster-relief efforts by being updatable in a pre-determined quick amount of time;
said receipt can have printed on it a donation disclaimer;
said receipt printing is automatic; and
said receipt printing overrides printing previously determined preferences.
